(19) United States
(12) Patent Application Publication
(10) Pub. No.: US 2022/0366289 A1
(43) Pub. Date: Nov. 17, 2022

(54) RELATIVISTIC QUANTUM COMPUTER / QUANTUM GRAVITY COMPUTER

(71) Applicant: James TAGG, Encinitas, CA (US)

(72) Inventor: James TAGG, Encinitas, CA (US)

(21) Appl. No.: 17/297,152

(22) PCT Filed: Oct. 16, 2019
(86) PCT No.: PCT/US2019/056588

§ 371 Date: May 26, 2021

Related U.S. Application Data
(60) Provisional application No. 62/750,471, filed on Oct. 25, 2018.

(51) Int. Cl. G06N 10/20; G06N 3/063

(52) U.S. Cl. CPC G06N 10/20; G06N 3/063

(57) ABSTRACT

In order to function reliably, a classical computer suppresses quantum uncertainty while a quantum computer harnesses uncertainty to provide additional computational resource. Both classical and quantum computers operate in a background dependent deterministic framework and process information in a step-by-step fashion. A quantum gravity computer, on the other hand, has indefinite causal structure caused by the interplay between general relativity and quantum mechanics and cannot be modeled as a step-by-step process. It does not ‘compute’ in the traditional sense but still processes information according to rules. Such a computer has greater power than a step computer and should have application to simulating systems where both quantum mechanics and general relativity re important, such as the early stages of our Universe. It may also serve as the model for the operation of the human brain, giving rise to such faculties as understanding, free will, and creativity.

### TECHNICAL FIELD

The subject matter described here relates to relativistic quantum computing, also known as quantum gravity computing.

### BACKGROUND

When an engineer uses the phrase ‘computer’ they usually mean a digital computer operating classically. These computers operate according to the same principles whether implemented as a wristwatch or a super computer. It is believed that all such computers are computationally equivalent to a Turing machine, save only the practical limitation of not having access to an infinite tape. It is proven that the many descriptions of computation—Turing machines, Church's Lambda Calculus and Post machines are all equivalent and have well understood restrictions—only calculating computable numbers and computable functions. The most significant non-computable function is the Halting Problem—proven not to exist as a computable solution in Turing's paper ‘On Computable Numbers With an Application to the Entscheidungsproblem.’ Many other problems have been shown to be non-computable by reducing them to the halting problem, the partial halting problem, Hilbert's 10^{th} concerning Diophantine equations and Rice's Theorem. These limitations pose significant restrictions on the power of traditional computers.

We are all acquainted with digital computers but there are other types of computer. Analogue computers operate on real numbers, rather than digital variables. Inputs are represented by analogue values such as the charge on a capacitor and a non-linear gate, such as a transistor or valve, is used to multiply the two real number values. There are certain benefits to analog computers. They can perform an infinite precision multiply—or some other complex function—in a single operation and they appear to accurately model the continuous physical values we believe exist in our Universe. There are many practical limitations to analogue computers because of the inability to precisely specify functions and the presence of noise which is impossible to suppress in an analogue computer. Digitization, the process of constraining analogue values to discrete bands allows us to arbitrarily reduce the effects of noise on a calculation and to perfectly model functions albeit with a limit to precision. For these reasons digital computers are the dominant computers today. Because analogue processes can be modelled to arbitrary precision on a digital computer it is not believed that analogue computation would have any greater power than a digital computer.

Quantum computers have emerged as a new computational resource and operate on qubits rather than bits, Qubits can represent 0 and 1, and any mixture of the two simultaneously and multiple qubits can be entangled to form a quantum register called a qubyte. Operations on quantum registers allow the implementation of algorithms such as Sher's and Grover's that use quantum parallelism to search solutions in parallel rather than sequentially. Since many natural processes are quantum in nature, for example, the folding of proteins, chemical reactions and the operation of catalysts, quantum computers have wide applicability. Because qubits can be simulated to arbitrary precision on a digital computer a quantum computer has the same power as a classical computer. By power we mean they calculate the same set of functions but with potential for enormous speedup when certain conditions are met. Regardless of whether a computer is classical or quantum it is subject to the Church-Turing limit, meaning it is unable to compute certain functions. The halting problem asks if it is possible to define a mechanical procedure that correctly determines whether a computation specified by its input would terminate, Many problems can be reduced to the Halting Problem showing they are also non-computable and such problems frequently arise in practice. For example, identifying computer viruses, analyzing program paths, and constructing mathematical proofs. Indeed, Rice's theorem says that no non-trivial feature of a computer program is computable and the partial halting theorem says you may not bi-pass the halting limitation by splitting your problems into subsets and computing these separately.

Quantum computers are not the end of the road. There are, in principle, things that are more powerful than a computer called ‘Oracles’ however opinions are strongly divided as to whether such things are physically realizable. We cannot call them machines as Turing defined the term as equivalent to a computer so when we talk of things that are more powerful than a computer we have to resort to terms such as mechanism or device. These mechanism or devices would be able to calculate functions that are not computable by a Turing machine or calculate functions that are computable in novel and more efficient ways. In this patent we describe a method for building a more powerful thinking device than a Turing machine called a quantum gravity computer (QGC), some people prefer the term Relativistic Quantum Computer (RQC) or Gravitated Quantum Device.

There is much disagreement on the naming convention for this new class of computer. Quantum Gravity (QG) has become synonymous with theories which attempt to quantize the metric of space-time rather than involve a more even-handed modification to quantum mechanics and general relativity. Computation is synonymous with algorithmic approaches carefully characterized by Alan Turing. We might better talk of a relativist quantum non-computer. Unfortunately, this is a rather unmanageable name and Lucien Hardy of the Perimeter Institute has already coined the term Quantum Gravity Computer so we will use this term. For those parties who disagree with quantum gravity computer QGC can also stand for Quantum General-Relativity non-Computer.

A quantum gravity computer, aka quantum general-relativistic non-Computer, is a mechanism where both quantum mechanics (QM) and general relativity (GR) are significant to the process of computation. QM is a probabilistic theory which treats time as a classical background property, while GR is a background independent theory where space and time are treated on an equal footing. Further, QM consists of two processes: the linear, reversible Schrodinger equation and the non-linear measurement process. There appear to be significant incompatibilities between quantum mechanics and general relativity during the measuring procedure. We do not know how to resolve these incompatibilities on a theoretical basis but we can ‘guess’ at the features of such a combined theory. Combining QM and GR will involve uncertainty in both space and time meaning that it is impossible to be sure the computer would proceed in deterministic time steps—indeed the concept of evolution of state over time may be meaningless in such a device as there might be no matter of fact as to the state of the system. A QGC will have indefinite causal structure meaning that deterministic machines would not be able to capture its operation. Therefore, a QGC cannot be understood in the framework of a Turing machine and cannot be simulated by a Turing machine. This inability to simulate a QGC on a Turing machine is presented as the simplest proof that such a machine has more power than a Turing machine.

QGC is inspired by examination of the operation of the human brain and by theoretical considerations regarding computable and non-computable functions. Theories of brain function spilt into two types, those which believe conventional physics can fully explain the operation of the human brain and those that believe new physics is needed. We will now describe some of the state of the art in computational models and certain enabling technologies.

Computational models for the operation of the human brain are the dominant paradigm presently. These models assume human thought is a classical computation and emerges from the inherent complexity and scale of the human brain. The lzhikevich spiking neuron model patents U.S. Pat. No. 9,311,594, US 2013/0297541, US 2014/0032458, US 2013/0297.542, US 2014/0156574 et al. provide the most literal attempt to directly implement the computational model for brain function in an integrated circuit. A neural network is constructed from neuron like elements implemented in silicon. They are interlinked and configured to ‘fire’ repeatedly according to an equation that models the firing of human neurons. The model neurons are connected to many other neurons through mod& synapses. These systems are able to implement deep learning algorithmic operation in a similar manner to programming a deep learning neural network on a GPU or TPU using Tensor flow or similar frameworks. The systems are able to perform a variety of artificial intelligence (AI) tasks, such as playing chess, go, image classification and driving vehicles but do not exhibit human like faculties such as intuition or ingenuity. It is argued that these faculties would emerge with sufficient scale and appropriate programming.

Another model for the operation of the human brain is described in ‘A Framework for Simulating and Estimating the State and Functional Topology of Complex Dynamic. Geometric Networks’, Marius Buibas and Gabriel A Silva. They describe a cellular based model for dynamic networks. In this model the encoding of information and action is in the dynamic operation of the network rather than a one-time static process. The network is stimulated with inputs and settles down to a steady state dynamic pattern of operation. The dynamic pattern encodes the operation. This system is implemented entirely classically but would lend itself to quantum approaches and is a particularly useful starting point for a quantum gravity computer.

Many other examples exist of classical computing systems designed to think like a human brain. IBM's Synapse system and Watson, Google's AlphaGo and numerous other examples. These systems are impressive at tackling well defined tasks but we argue they don't understand the tasks they are tackling and this lack of understanding means they are unable to generalize their own algorithms or innovate new ones.

In 1998 Roger Penrose and Stuart Hameroff proposed new physics is needed to explain brain operation and the human faculty of understanding. Such physics would involve a solution to the inconsistencies between quantum mechanics and general relativity and was labelled Orch-OR: Orchestrated Objective Reduction of the wave function. The objective reduction (OR) part of the theory is a testable alternate to interpretations of quantum mechanics such as the many worlds hypothesis. It postulates that when a quantum process displaces sufficient mass, quantum superposition will collapse. They propose the human brain orchestrates (Orch) this collapse to provide computational resources, hence the name Orch-OR. In order for this system to be fully understood a theory of quantum gravity (or rather quantum general relativity) is required and this is not yet available.

In 2007 Lucien hardy proposed a framework for a quantum gravity computer based on a model that does not attempt to create a theory of quantum gravity but never-the-less provides a general framework for modelling its operations No practical implementation was proposed but certain theoretical predictions were made, in particular the potential to have greater computational power than a Turing machine.

Despite not having a fully (or even partially) formulated description of quantum gravity this does not prove an impediment to constructing a quantum gravity computer. Many practical computers were built well before the details of quantum mechanics were worked out. This patent describes principles for building a computer that would be sensitive to both quantum and general relativistic effects. Such a device could be used as a way to probe problems in this domain as well as providing a new computational (or rather a new non-computational) resource.

Inspiration for this approach has emerged from studies of the human brain. It has been proposed that computation is performed in the brain by photons interacting with proteins along the surface of microtubules. It is known that the human brain is highly photo active. Travis Craddock of Nova University has proposed a method for modelling the motion of photons along microtubules with a similar mechanism to the way we understand photosynthesis moves energy to the reaction centers.

This patent will describe several ways in which such computation may be implemented and in particular an architecture for photonic switches implemented using graphene quantum dots. Photons do not interact with each other intrinsically but rather indirectly through photon-photon interactions via electromagnetically induced transparency (EIT), photon blockade, Rydberg blockade and Giant Faraday rotation along with artificial atoms including superconducting boxes and semiconductor quantum dots (QDs). We now provide a selection of relevant references to the state of the art in graphene based optical computing,

Photons must be controlled and control must also be subject to entanglement and superposition. The Nature article, “Nonlocal Position Changes of a Photon Revealed by Quantum Routers” https://www.nature.com/articles/41598-018-26018-y describes a mechanism to permit this.

Photons Carrying Spin and Orbital Angular Momentum, https://www.nature.com/articles/srep27033 Graphene quantum dots mill respond to both these parameters and can be modulated in accordance with the paper Electrooptics of graphene: field-modulated reflection and birefringence M. V. Strikha, F. T. Vasko.

Tuned layers of graphene can provide Giant Faraday rotation in single- and multilayer graphene https://www.nature.com/articles/nphys1816

The hallmark of silicon photonics is in its low loss at the telecommunications wavelength, economic advantages and compatibility with CMOS design and fabrication processes. These advantages are however impeded by its relatively low Kerr coefficient that constrains the power and size scaling of nonlinear all-optical silicon photonic devices. Graphene, with its unprecedented high Kerr coefficient and uniquely thin-film structure, makes a good nonlinear material to be easily integrated onto all-optical silicon photonic waveguide devices.

Routing of photons can incorporate both spin and angular momentum. Quantum Router for Single Photonic transistor and router using a single quantum-dot-confined spin in a single-sided optical rnicrocavity (does not require non-linearity) https://www.nature.com/articles/srep45582 Describes a method for making quantum dot based gates which can switch photons with other photons providing a photonic transistor.

Techniques to deposit Graphene on Silicon for making quantum devices are understood for example KR101493334B1, Method for forming graphene pattern, and electronic element and quantum element having graphene pattern manufactured thereby and US20130057333A1 describes Graphene valley singlet-triplet qubit device and the method of the same.

Deep Ultraviolet Photoluminescence of Water-Soluble Self-Passivated Graphene Quantum Dots. Department of Applied Physics, The Hong Kong Polytechnic University, Hong Kong SAR.

Finally, a quantum gravity computer must cope with noise derived from both relativistic and quantum sources. The article Quantum Error Correction for Beginners https://arxiv.org/pdf/0905.2794.pdf. gives a summary of quantum error correction techniques. We will address this issue of error correction in a QGC.

### SUMMARY OF THE INVENTION

In this patent we describe the general principles of operation along with methods for implementing a quantum gravity computer (QGC) also known as relativistic quantum computing. Practitioners skilled in the art presently use very complex experimentation at the frontiers of physics and computer science. We will describe several embodiments that might be realizable by practitioners with different skills namely; physicists, biologists and computer engineers along with at least one embodiment in detail. Many quantum computer paradigms can be modified to implement quantum gravity computation and we layout the principles that should be applied to a quantum computer to move it to a state where general relativity will also be a factor and they could harness QGC. It should also be noted that existing quantum computers may be subject to QGC but perceive this as a flaw. If a quantum computer moves too much mass-energy during its computation it may cause collapse of the wave function which will appear as a decoherence error. The cooling and isolation in present quantum computers is largely to avoid such early decoherence effects.

A quantum gravity computer is a computer where the effects of both quantum mechanics and general relativity are significant. The unit of information is still the qubit; however, qubits can no longer be specified as conceptual entities independent of location. Qubits are embedded in space-time. Likewise, gates cannot be assumed to lie along a time-like path operating on the qubits in a step-by-step fashion. In the case where gates are so configured the model reduces to that of a quantum computer. Despite not having a well formulated theory for quantum gravity (or even agreement on the naming of the field) we can define parameters for a practical mechanism that is sensitive to the effects of quantum mechanics and general relativity and build such a mechanism. It is difficult for the human mind to conceptualize quantum gravity computers as regular notions of cause and effect, and time break down. A similar lack of intuitive models has not prevented the development of quantum computing.

Key theoretical underpinnings to our model include:

No signal can be sent faster than the speed of light.

Quantum collapse happens instantaneously.

There are no hidden variables, spins/polarizations do not have a reality until ‘measured’.

Gravitational waves travel at the speed of light,

Decoherence is NOT measurement, it is a reversible operation.

The features of a quantum gravity computer are:

Information can be represented by qubits.

Collections of qubits can entangle to form larger informational entities: qubytes or quantum registers.

Qubits and gates physicalize with space-time metric properties. They are located at a point x, y, z, t in the metric with momentum and consequent degrees of uncertainty.

Any change in a qubit will have some effect on the metric.

Gates in the model must be capable of operating on quantum states and move appreciable mass-energy so that the metric of space-time is modified.

Gates need to move the correct order of mass when they operate, not too much and not too little—large enough to cause collapse when taken with other gates but small enough not to self-measure in a single operation. The time to collapse is given by

$$T \approx \frac{ℏ}{{E}_{g}} ,$$

where E_{g} is the gravitational self-energy of the system and h is the reduced planks constant.

The topology of the computer is designed to maximize this self-gravitational interaction.

The topography of the computer needs to be of the correct scale such that processing can occur at the boundaries of light cones. This essentially means that processing elements need to be arranged so that signals travelling at the speed of light reach the next processing element at around the same time as the signal becomes significant to the operation of the gate—so called ‘just in time’. Thus, a change in the metric will affect whether the signal arrives in time to be an input or two late to be an input to a next stage. The only feature of this model is that inputs are on the boundary of space-like and time-like effects. One could construct a computer with interstellar proportions or microscopic proportions. In our preferred embodiments we will prefer microscopic devices with gate spacings of the order of microns as computers of such scale will compute at time intervals interesting to human beings.

Quantum operation and movement of mass may be separately implemented by specialist gates.

The Space-time metric is placed into superposition by the movement of mass-energy and effects calculation within the QGC.

Quantum uncertainty coupled with the arrangement of gates at the scale of light cones leads to indefinite causal structure.

Certain topographies of the computer will cause more space-time metric interaction than others, for example interdigitated layouts. (Such a layout appears to be a feature of certain human brain neurons called pyramidal cells)

A measurement process is not required. The read-out mechanism is self-triggering and is a competitive/cooperative process analogous to the freezing of a liquid. It might trigger from multiple seeds where one wins out according to a non-deterministic process. The process will be described in greater detail later.

The process occurs in a single, indivisible instant and is thus not deconstructable into cause and effect. This renders it impossible to simulate on a step-computer.

Quantum mechanical state is non-separable, in that a system is not simply a sum of its parts, quantum gravity state is also non-combinable. Two QGC mechanisms cannot be combined and modelled deterministically on a third. This means it is not possible to combine a unit with its watchdog and obtain a combined unit which cannot be proven not to halt.

QGC computers get their power from avoiding the trap of looping indefinitely.

Despite no requirement for an explicit measurement process it may be helpful to push the self-collapse over the edge from time to time to obtain a regular readout. Without such regular readout the system might not be able to respond to external events in a timely manner or maintain certain time critical functions. This is a possible explanation for the purpose of regular EEG patterns in the human brain.

The general implementation features of a quantum gravity computer are:

Computation is a highly dynamic process. Because computation must occur before the light cones intersect computation is implemented through direct optical switching gates rather than trapped long lived qubits.

The system should work at room temperature because it does not involve long lived trapping of quantum states.

Benefits of the Invention

General Benefits
1 It is, in principle, able to solve any problem set to it and does not fall foul of the halting problem.
2. Reduced power consumption for solving normal problems.
3. It can display the human facilities of understanding, creativity and free will,

Room Temperature Benefits
1. Many fewer problems of construction and monitoring
2. Ability to use biological proteins that would denature near absolute zero.
3. Intrinsic error correction.

### BRIEF DESCRIPTION OF THE SEVERAL VIEWS OF THE DRAWINGS

FIG. 1 Proof that the Halting Function cannot exist (in a step computer)

FIG. 1a Mathematical Object with no concept of time, for illustration purposes

FIG. 1b No combination feature

FIG. 2 Spacetime, cause and effect diagram

FIG. 3 Quantum gravity gate

FIG. 3a quantum gravity no-op (QGNO) gate

FIG. 4 Metric distortion during processing

FIG. 5 Topology of a quantum gravity computer

FIG. 6 Measurement Gate

FIG. 7 Quantum Circuit equivalency

FIG. 8 Distributed Measurement

FIG. 9 Two input quantum gravity gate

FIG. 10 Conceptual layout

FIG. 11 No causal paradox

FIG. 12 Neural Network of a quantum gravity computer

FIG. 13 Configuration of the system

FIG. 14 Process of operation of a QGC

FIG. 15 Collapse mechanism of a QGC

FIG. 16 Error Correction in a QGC

FIG. 17 Plan Elevation of one implementation of a QGC

FIG. 18 Side Elevation of one implementation of a QGC

FIG. 19 Biological QGC

### DETAILED DESCRIPTION

The logical building blocks of a quantum gravity computer will be described along with the differences between quantum and quantum gravitational computing such that a person skilled in the art could make the necessary modifications to any quantum computer to enable it to perform quantum gravity computation. Several embodiments of devices optimized for quantum gravity computation will be described including a proposed graphene-based room temperature optical quantum gravity computer.

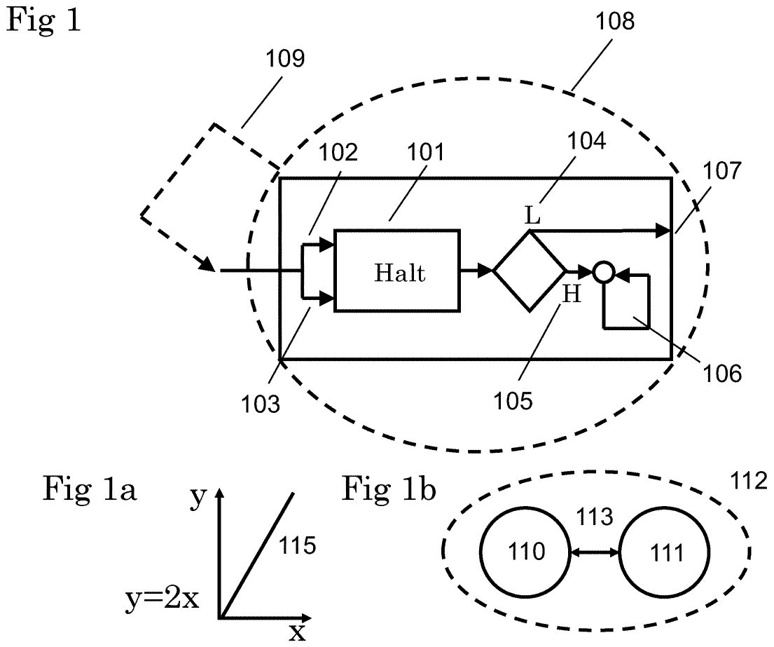

The existence of a halting function was a fundamental question in mathematics at the turn of the 20th century and the proof that no such function could exist has defined the limits of computation since Alan Turing and Alonzo Church prove it in 1935-36. FIG. 1 illustrates a visual proof that the halting function cannot exist on a step computer. First assume that halt does exist and construct a procedure 101 that performs this function, label this ‘Halt’. No attempt to specify the procedure is required as its existence will be disproven. The halting procedure 101 takes another program as input 102 and predicts if that program will halt if run on an input 103. Halting means that the computer stops and indicates it has reached a conclusion True (T) or False (F).

To disprove the existence of Halt, proceed as follows. Construct a new algorithm K 108 that takes Halt's output as its input and does the following

1. if Halt outputs “loop”(L, 104) then K halts 107,
2. otherwise if Halt outputs “halt” (H, 105) K loops forever 106.

Since K is a program, let us use K 108 as the two inputs to K 109 which are input to Halt 102, 103.

If Halt says that K halts then K itself would loop forever. If Halt says that K loops then K will halt. In either case Halt gives the wrong answer for K. Thus, Halt cannot work in all cases. There is an input that causes any solution Halt to fail, Paradox!

The only resolution of the paradox is that the Halt function cannot exist. The proof holds for all general computational systems equivalent to a Turing machine which we have characterized as step computers. That is to say computers which have a progression of states and transition rules from state to state.

There have been a number of attempts to avoid the paradox and reinstate a halt function. One solution is to construct a computer programming language that does not permit infinite loops, either by ensuring there is no construct in the language that will permit an open-ended loop 106 or by constructing a compiler that bounds checks programs to ensure that there is no infinite loop case. These solutions fail. By Rice's theorem it is impossible to construct a computer system that guarantees any non-trivial property of another program—in this case bounds checking is non-trivial and a compiler is non-trivial. If a language cannot enter an infinite loop it is not Turing complete and will not compute certain functions. Thus, attempts to escape the Turing limit are either faulty or result in limited computing systems. On a practical note all computing systems that purport to avoid the halting problem must eventually run on firmware and ultimately a hardware machine and that machine cannot be guaranteed not to fall into an infinite loop.

In a quantum gravity computer, a different approach is taken to removing the looping problem. The essence of the loop problem is that there exists a deterministic step-by-step procedure that will return the system to the same state in the future. (This is how the infinite loop 106 works). A way to side-step this problem is by removing the idea of the step-by-step evolution of state. This might seem impossible but there are many mathematical objects for which there is no concept of step or time. By way of analogy, the equation y=2x is an object that performs a ‘computation’ but does not do so with any concept of step or time; y is simply equal to two times x. There is no moment in time where this is not so, and a later point when it is. Thus, time steps do not need to form an integral part of the derivation of one piece of information from another. This does not mean there are no rules that govern the relationships. A QGC is not chaos. It is a different approach to manipulating information. We should state that unlike our analogy above a QGC does perform calculations which evolve over time however, they are not rigidly and deterministically step-by-step procedures.

In a system which cannot proceed step-by-step it becomes possible to introduce a watchdog to prevent looping. The simplest model is a two-entity model with a mutual watchdog. FIG. 1b illustrates two elements 110 and 111 which each process information and provide a watchdog function to the other 113. In normal step computers this model can be combined and modelled as a single process 112. To prove this is possible we can see it is simple to run a step from 110 and then a step from 111 on the third machine 112. The combined system cannot be guaranteed to halt and therefore the mutual watchdog function fails. However, a non-step computer cannot be combined and modelled by a third as it lacks definite state to permit interleaving.

This ability to process information without necessarily relying on step-by-step computation stems from features of our device. Firstly, there may be no matter of fact as to the state of the system at any time. The Kochen-Specker theorem shows that the state of a Boson (spin particle) has no matter of fact until measured. Secondly the causal structure cannot be statically modelled. Thus, in such a device it may be impossible to specify a state or determine that you have returned to that state at a later time because there is no meaning to ‘later time’ and no matter of fact to state. While these concepts might seem fanciful on a macroscopic level and in conflict with the causal structure of general relativity, all that is needed for a QGC to compute hitherto non-computable functions is a brief departure from macroscopic determinism. We will now describe how such a departure could be engineered.

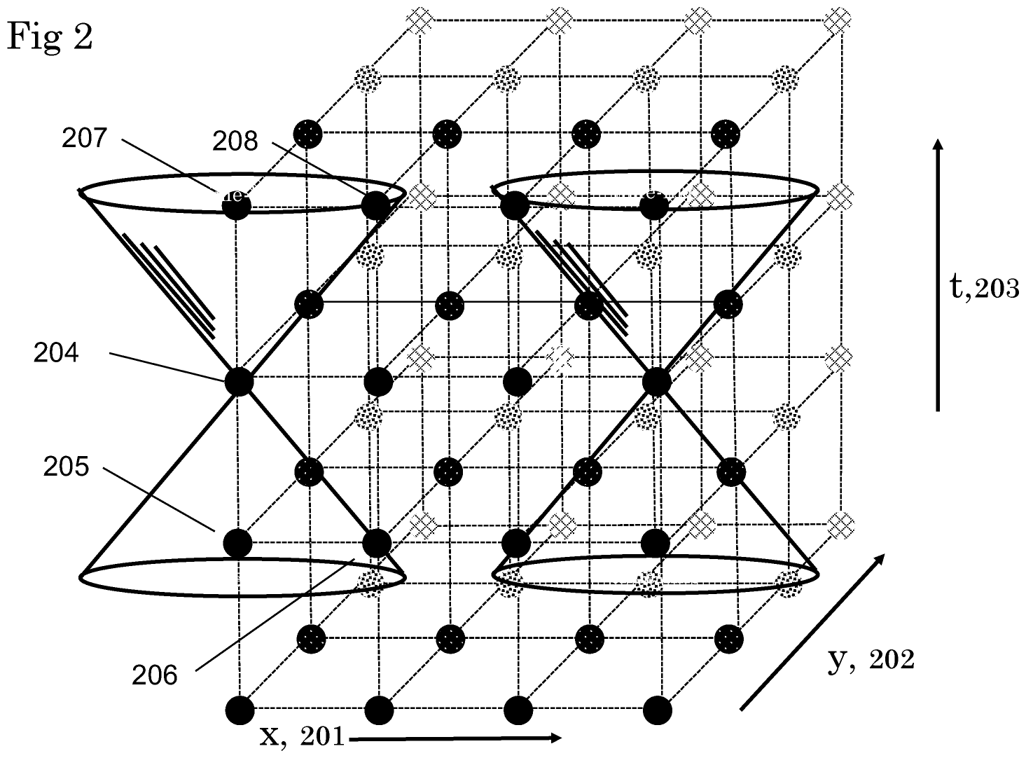

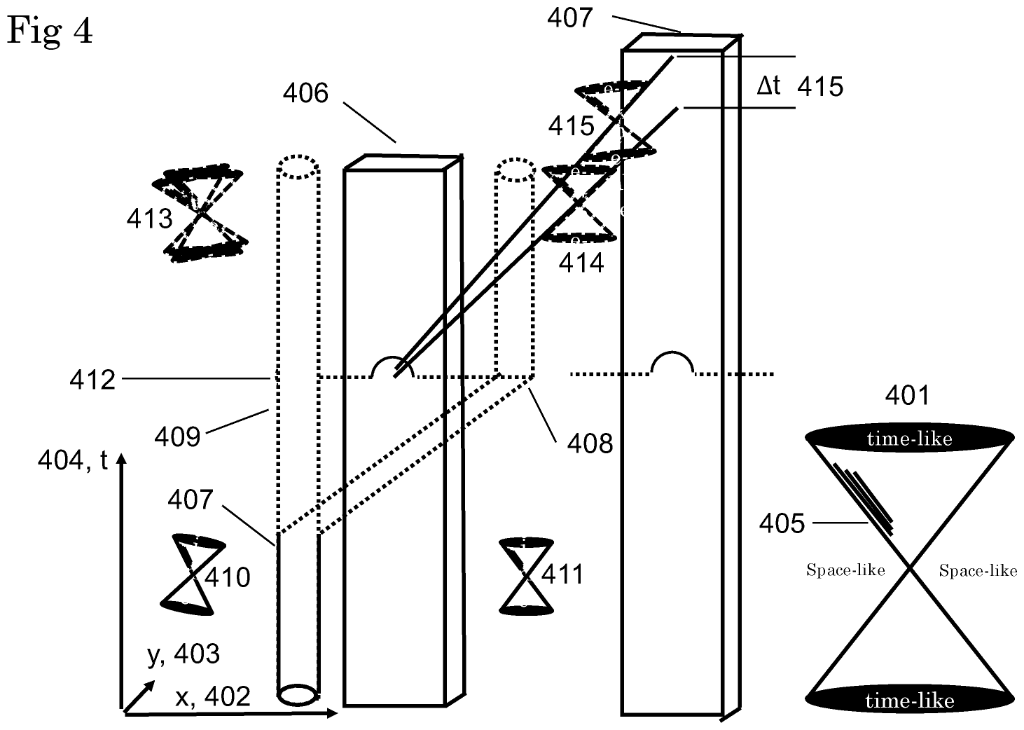

FIG. 2 Illustrates schematically a block of spacetime in a general relativistic framework with two light cones centered on points in the grid, the first labelled 204. We should immediately say that blocks of spacetime do not exist in Relativistic Quantum Mechanics (RQM) but they are a useful notion to setup our understanding: The grid should be imagined as fuzzy and in flux. In FIG. 2 the dimensions x 201, y 202 and t 203 of space-time are illustrated while z must be imagined. A grid of processing elements is arranged in this space. The light cones from those elements indicate the degree to which different areas of spacetime are ‘time-like’ and ‘space-like’ separated and therefore the causal connection between computational elements. (Space-like and time-like regions of a light cone are illustrated at 401 of FIG. 4). The center of the cone 204 represents some arbitrary small region in space-time at which we have placed a processing element. The elements can communicate along light cones using encoded light pulses. Each processing element might be imagined as a small microprocessor of around the size of a grain of sand, able to receive and send encoded light pulses, through polarization, time bucket or other quantum optical encoding scheme. These microprocessors would also need the ability to maintain quantum coherence and entanglement of the photonic inputs and outputs they process. Such processors can be created in principle using, for example, Linear Optics Quantum Computation (LOQC) elements or indeed any arbitrary quantum optical device including the non-linear devices described in the introduction. We will describe methods to make such processing units later, and such units can be as simple as a single logic gate or as complex as a commercial microchip without loss of generality to the design.

Elements that are time-like separated 205, 206, 207 & 208 are causally connected to element 204 as they fall within the past or future light cone of 204. In the case of 205 & 206 this is a cause relationship and 207 and 208 is an effect relationship. Thus 205 & 206 may form inputs to the operation performed by 204 and the output of this operation may form an input to elements 207 and 208.

In a classical computer there may be regions that are space—like separated—not causally connected. At the dock speeds present in a modern-day computer it is possible for a signal to be still in flight along a wire at the time when the next calculation is to be performed. If a calculation is dependent on such a signal the computer must be organized to wait for that signal before calculation is undertaken. For this reason, modern computers distribute a dock signal and synchronization information that ensures computational elements ° wait' until they are within the light cone of a previous computation. In the language of this diagram sufficient time t 203 is allowed to pass before a computation is made so that all relevant inputs fall within the light cone of a processing element.

We will shortly see that the introduction of relativistic quantum mechanics confuses this picture and destroys the dean notion of space-time and cause and effect.

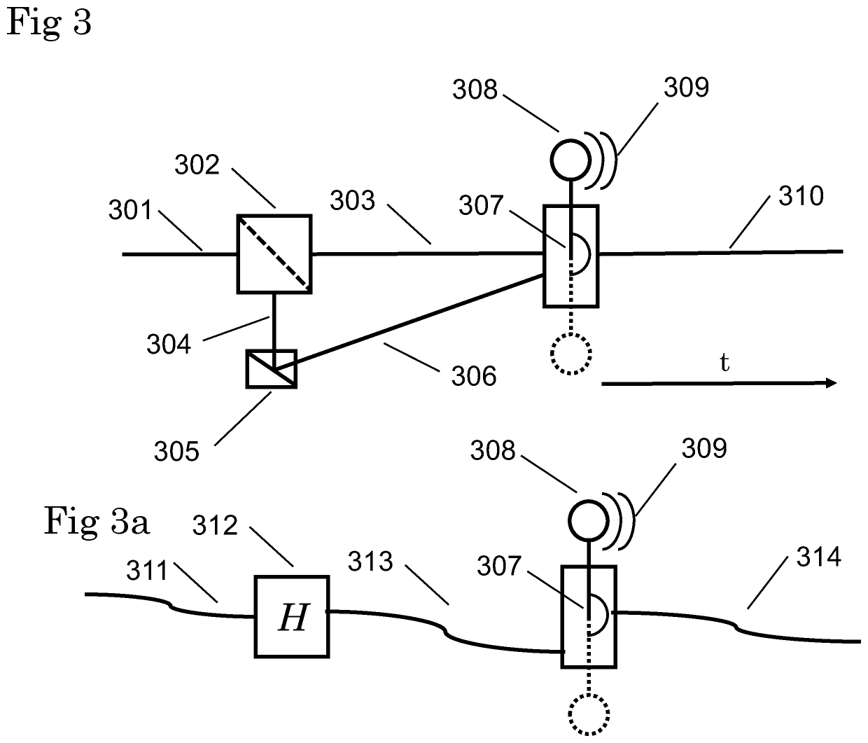

FIG. 3 Illustrates schematically the operation of a quantum gravity gate 310 implemented using optical elements. (It is possible to construct a universal quantum gate from linear optical elements). This gate is a simple quantum gravitational gate and conceptually similar to the Hadamard gate for purely quantum computation. A photon 301 enters the apparatus from the left and is split into two paths by a beam splitter 302, a straight path 303 and a reflected path 304. The photon is now in a superposition of states traversing path 303 and 304 simultaneously. The mirror 305 serves simply to redirect the photon to the gate 307. The gate at 307 could make any arbitrary quantum computation action but in this instant, we will assume it performs a quantum no operation (no-op) and outputs this on 310. The gate is gravitationally active: It will move a mass 308 to one of two optional positions depending on input to the gate. The mass moves to the upper location if the 303 photon arrives earlier than the 306 photon path-time bucket encoding. When the mass 308 moves it will distort spacetime by emitting gravitational waves 309 that will change the metric and therefore the length of the two paths 303 and 306. In this diagram the paths have been shown as of distinctly different lengths to illustrate the concept, but they can be redrawn so that the paths 303 and 306 are similar in length. Tiny variations in the metric of space time will affect whether a photon travelling along 303 appears before or after the expected arrival of 306. It might be thought this causes a paradox. If photon 303 arrives first the mass is moved to the downward location and shortens spacelike paths in the lower half of the diagram. However, this means that the 303 photon arrives after the 306 photon. In a general relativistic frame this is not the case because the modification to the metric spreads as a gravitational impulse wave 309 at the speed of light in all directions. However, quantum mechanical considerations introduce uncertainty and it is therefore impossible to say with certainty whether the inputs to the gate are not affected by the mass displacement. This might appear, at first site, as a ridiculous statement, an output having effects on the inputs. However, there is no restriction on this in principle. If time is uncertain we cannot be sure of the causal relationship. There might be a concern that such a causal relationship would introduce grandfather paradoxes and therefore render the gate ineffective or illegal in some way. However, quantum mechanics is probabilistic. According to David Deutsch although a grandfather paradox does occur in a digital system it does not occur in a probabilistic system. Changing the probability of you killing your grandfather does not render your existence impossible (and therefore paradoxical), only less likely. Therefore, this simplest of gates, a quantum gravity gate or a relativistic quantum gate is introduced as a building block for our QGC.

In FIG. 3a we generalize the model a little further by replacing the Michaelson beam splitter apparatus with a Hadamard gate 312. This gate modifies the base states of |0> and |1> to a superposition of |0> and |0> and |1> with equal probability. The QG no-op gate 310 of FIG. 3a, which had been imagined as a time-bin encoded photon timing operation in FIG. 3 can be implemented by any quantum gravity no-op (QGNO) gate. The only function of the QGNO gate is to move some mass based on the operation of the gate without making any appreciable modification to the quantum state. It is an open question whether no appreciable modification means no modification at all or a modification that is sufficiently small s to permit the quantum operation to continue with the application of quantum error correction. We must assume that some element of the mass movement causes information to leak from the quantum gate into the environment and this leads to some level of decoherence or broader entanglement. This puts a limit on the fidelity of the system in the absence of error correction. We further replace the ‘wires’ of FIG. 3 (301, 303, 306, 310) with a relationships (311, 313, 314) in FIG. 3a implying no time wise relationship and no one-to-one mapping. This is because the movement of mass can modify the spacetime metric thus modifying the causal relationship between logical elements. It is possible that the output of a gate could also function as an input to the same gate, either directly or via an intermediary gate.

FIG. 4 represents a gate depicted in the light cone diagram coordinates of FIG. 2. The diagram has been rotated relative to FIG. 3 so that time now flows in the vertical direction. (Changing coordinates is a common feature of discussions of this topic.) Again, the diagram shows only two dimensions of space 402, 403 and one of time 404, given the drawing is on a flat piece of paper one of the spatial directions is shown through the common perspective practices of space-time illustrations. In the embodiment described, processing is performed using light and therefore propagation of signals follows the extremes 405 of the light cones 401. Gates and their corresponding mass displacements are depicted as vertical structures 406 & 407, showing that they do not move in space and are present throughout time. It might be imagined that some signals have problems propagating ‘thru’ objects however one must remember there is an additional unillustrated dimension of space available to use. As each gate 406 operates it moves mass 407 into superposition 408, 409 and mass causes the metric to distort illustrated by the tilting of light cones. In general relativity, the metric tensor (abbreviated to the metric) captures all the geometric and causal structure of spacetime being used to define notions such as time, distance, volume, curvature, angle, and separating the future and the past. It is simply depicted as light cones in this diagram. It can now be seen that the performance of subsequent gates depends both on the signals that arrive and the metric. This is because changes in a gates state moves mass (strictly speaking also energy and momentum.) This change in the causal structure of space-time means that some signals may be brought into the past causal light cone of future events and therefore become causes, whilst if things go the other way they would cease to be causes. At a larger scale it can be imagined that the very order of gates is uncertain. Cause and effect and certainty of causal structure are not preserved in this construct. Despite this it is possible to manipulate information according to well defined rules.

In the figure we can see that once the gate has operated and switched the light cones 401 become uncertain. Light cone 410 is tilted towards mass 407 whilst light cone 411 is less affected as it is further from mass 410. After operation of the gate 406 at time 412 the masses are placed into superposition 408 and 409. This causes light cones to have uncertainty and appear ‘fuzzy’ 413, 414 & 415. The fuzzy light cone at 414 is separated so we can see its alternate 415. Tracing the causal line from gate 406 to gate 407 we can see a distinct difference in the arrival times of signals Lit 415 depending on the switching state of gate 406. If gate 407 operates based on time buckets the gate will operate based on the uncertainty.

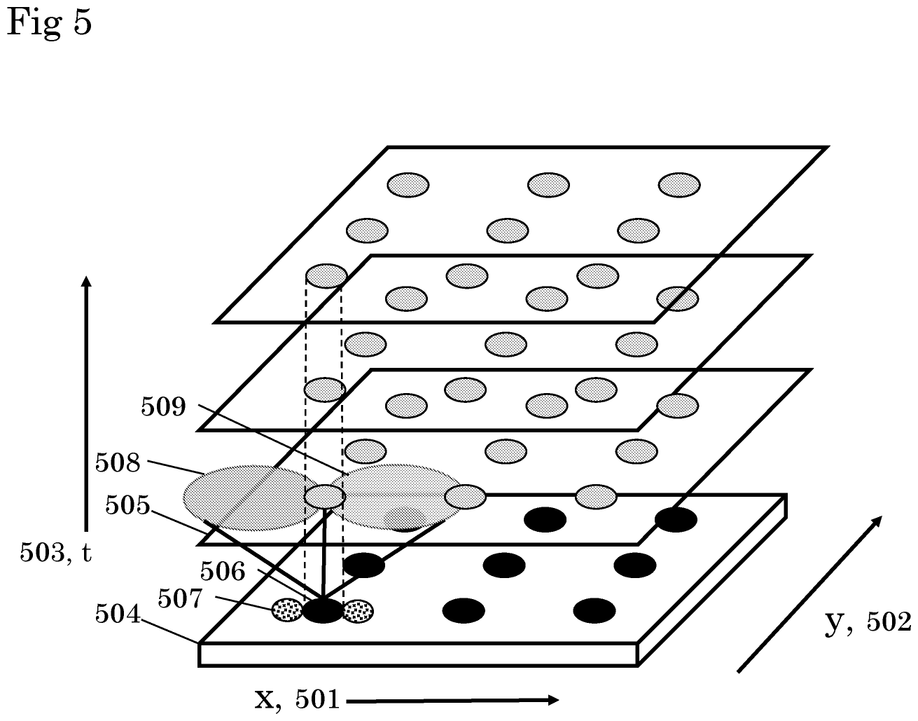

FIG. 5 Illustrates the general arrangement of a quantum gravity computer using optical switches such as graphene dots or tryptophan molecules. The upward direction 503 represents time while x 501 and y 502 represent two spatial dimensions and the slices represent equal time slices. (Note this is a convenience and there is no such thing as an equal time slice in a quantum gravity computer due to uncertainty in the metric.) A z dimension is not illustrated and for this diagram is not necessary as we imagine that the processing system is similar to a two-dimensional silicon chip. At each slice the first two labelled 504, 505 in our illustration the quantum dot—gates 506 have an element in a superposition—507 labels the left element of the two possible states. These superposed elements each cause a different metric distortion. The future light cones 508 and 509 are therefore defined by whether element 507 is in the left or right position. Since this is uncertain the future light cones from this gate can affect different groupings of dots in future time periods in an uncertain basis, Cone 508 only affects the bottom left quantum dot on the chip substrate while cone 509 affects two dots. The metric distortions are exaggerated for illustration purposes, in a real chip the quantum dots would be far more densely packed and the metric distortions needed for different causal relationships would be small. The substrate system can be silicon wafer technology that will support graphene on silicon so that part, or all of the graphene can be suspended above the silicon wafer. The graphene can flex or move in response to excitation signals putting it into physical superposition. Each graphene dot is influenced by an electrical circuit allowing the strength of optical coupling to other elements to be adjusted.

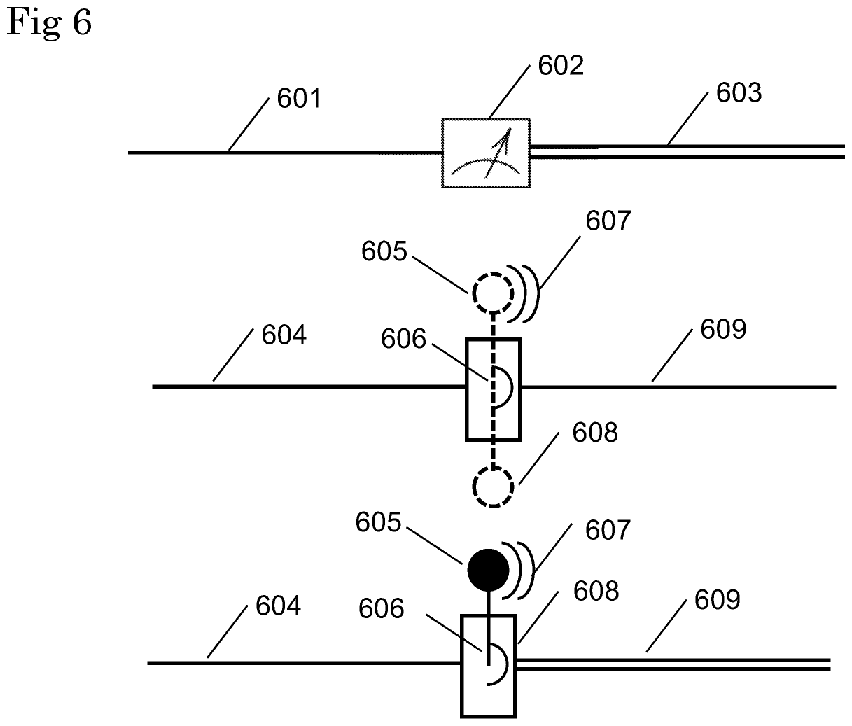

FIG. 6 illustrates the QGC equivalent of the ‘measurement’ gate in a quantum computer for a QGC. In a regular quantum computer an element is provided which does not obey the normal mechanics of other gates in the system. It is an irreversible measurement mechanism 602 and application to the quantum state results in a collapse from the superposed 0|1 601 state to either |0> or |1> 603 with a given probability—usually 50:50. This is essentially an external process applied to the quantum computation. In the QGC this measurement process is replaced with a gravitational gate 606. AH gates within a QGC will act as gravitational gates because any change in state or superposition of states will affect the metric tensor. However, a QGG is a special gate that amplifies the quantum superposition to a level that will self-collapse in a human scale time frame, typically 100 ms to 7 seconds when taken with other gates. Thus, an input 604 will drive the gate 606 into a superposition 607, 608 gravitational waves will propagate and the gate will make some output 609. If sufficient mass is involved 605 having a critical mass according to E_{g} then the single gate will self-collapse and make an irreversible output 609. In this case the gate is identical to the measurement gate of quantum mechanics save for the fact that it is no longer an ‘external’ effect but rather consistent with the operational model.

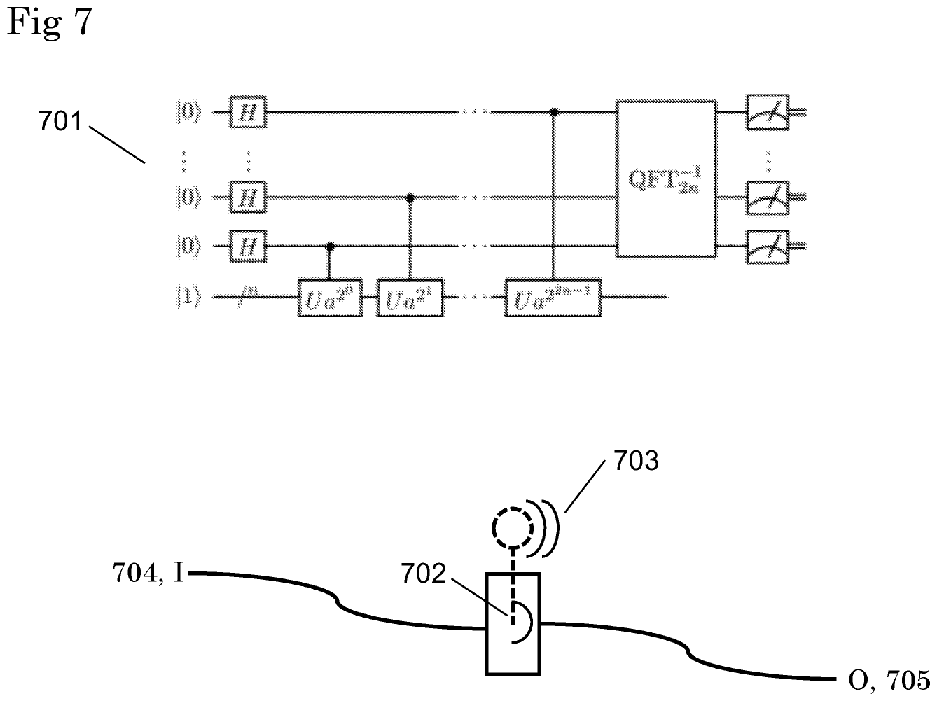

FIG. 7 Illustrates the QGC equivalent of a circuit in a standard quantum computer. In a QGC all elements in 701 can (and must be) replaced by a gravitationally active gates 702. In order to preserve the quantum computer operation, the computational gates are replaced with low mass action elements 703 operating on inputs I, 704 and giving outputs O, 705 and the measurement gates are high mass action elements 703 with a larger mass. This generalizes the QC to a QGC but at the expense of the ability to implement deterministic algorithms. Power is achieved by implementing new forms of ‘algorithm’ available to QGCs the most readily implementable being a deep learning QG neural network.

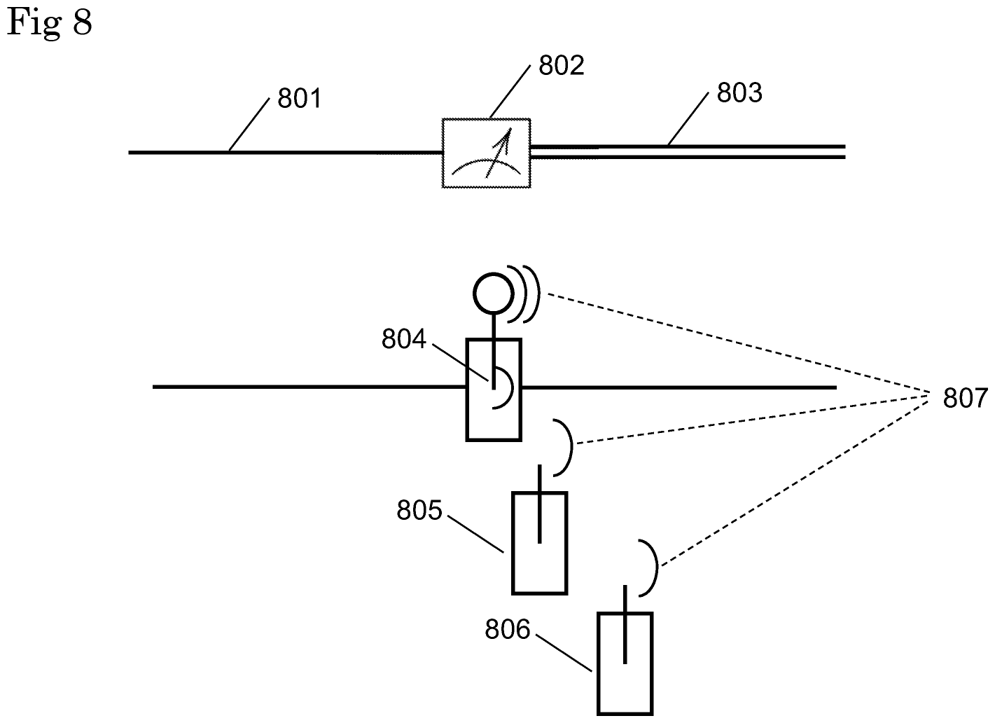

FIG. 8 Illustrates the distribution of measurement elements in a QGC so that the self-collapse is formed from more than one gate mass. The summing of metric distortions from individual gates 807 will reach the critical E_{g} level in some time T. The measurement gate described in FIG. 6, 801, 802, 803 is affected by the accumulation of metric distortions from a set of QGGs 804, 805, 806. This location of space-time 807 now has sufficient distortion to modify the metric above the critical E_{g} limit.

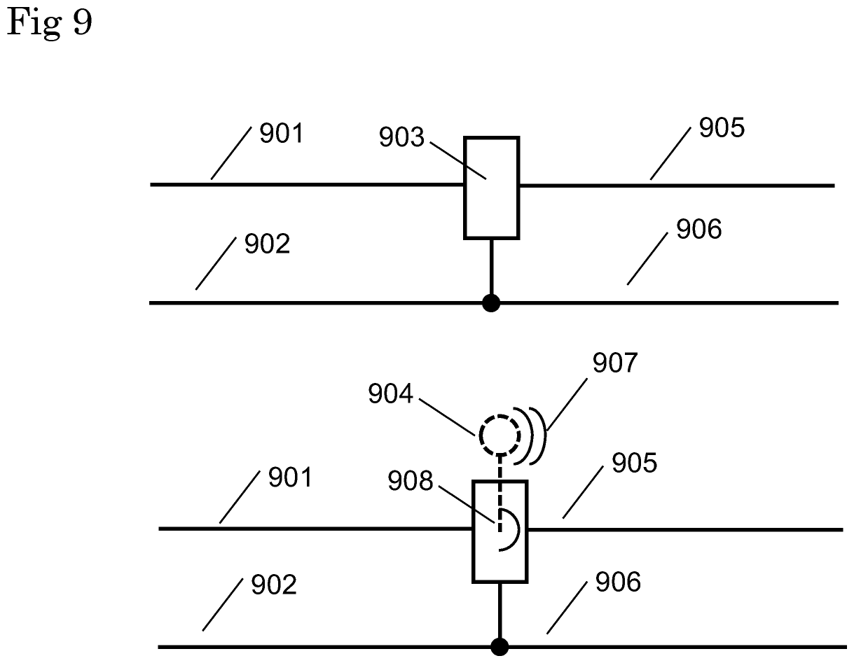

FIG. 9 Illustrates the QG equivalent of a general two input quantum computer gate. Inputs 901 and 902 are processed by 903 to form outputs 905 and 906. We may replace the general gate 903 with a general GQ gate 908 Provided that the system is subcritical WRT E_{g} mass will be moved 904 and modifications to the metric will start to propagate 907.

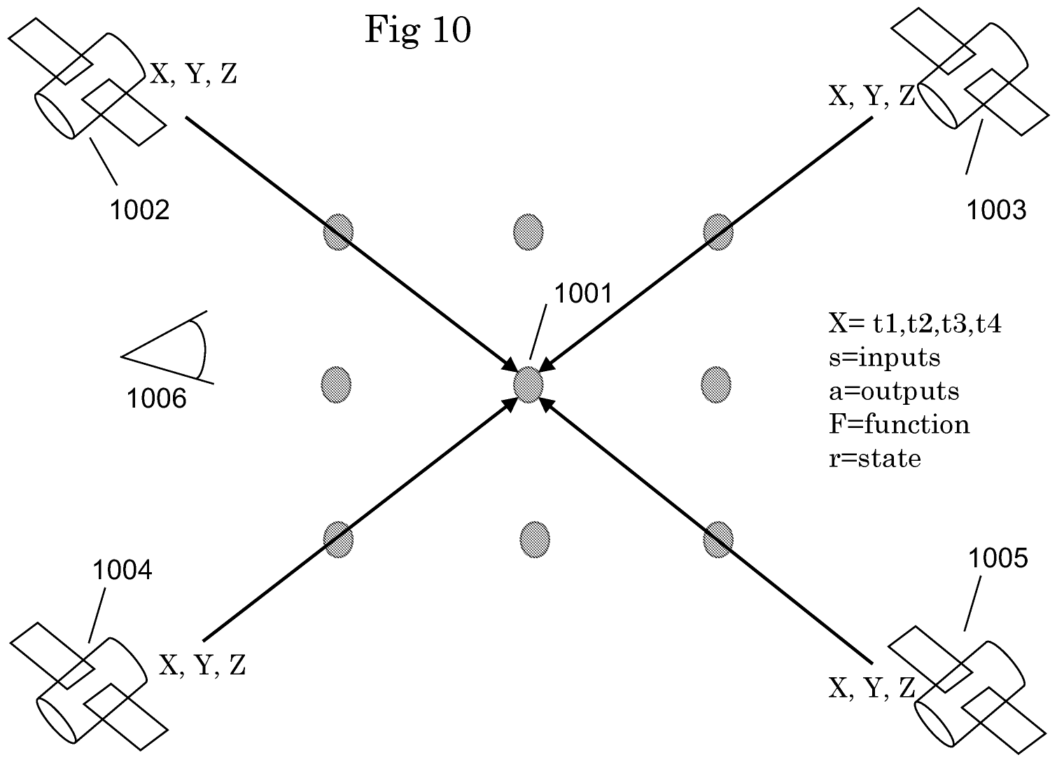

FIG. 10 Illustrates the arrangement of a conceptual QGC as described by Lucien Hardy so as to allow the reader to understand how a point in space-time can be both in existence and uncertain at the same time. A computation element 1001 is located in space time. It receives signals from four GPS satellites 1002-1005. The computation element can calculate its position x, y, z, t with respect to the satellites (for which it might have a flight plan) and therefore knows its own location in space and time. However, from the point of view of the observer 1006 x, y, z and t might be uncertain or there might not even be a matter of fact as to what they are. For example, the computational element might be the subject of a calculation which puts t into two places at the same time—a ‘cat’ state. Thus, we could not run a computation to determine what happens next to this system because there is no matter of fact as to the starting state of the system. Never-the-less the system could follow rules. Plotting observations of the state along the t axis would show the system appears to evolve over time.

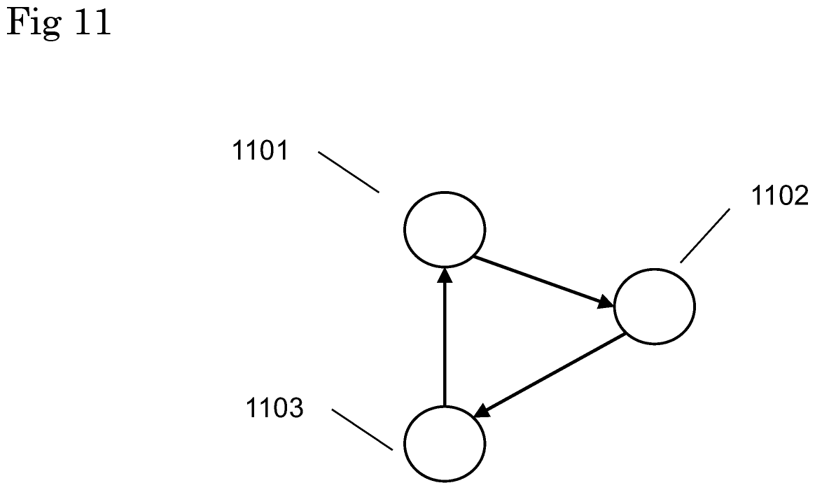

FIG. 11 Illustrates a state which may occur within a QGC. Elements form a causal rings where an element may be its own cause. Element 1101 affects element 1102 which in turn effects element 1103 which is an input to element 1101. In a classical system such a ring would be unremarkable as it is assumed that time flows during operation such that each gate affects the next at successive time intervals but in a QG system this cannot be guaranteed and gates may respond to outputs in arbitrary time order, gate outputs may be their own input. In a quantum system—as opposed to a classical system—this does not result in grandfather paradoxes as cause and effect relationships are probabilistic. The grandfather paradox occurs if an effect travels back in time and deletes its cause—killing one's grandfather, for example. If an effect travels back in time and affects the probability of a cause it is permitted. Another paradox commonly used to argue against time reordering of cause and effect is the Shakespeare paradox. A person memorizes the works Shakespeare, travels back in time and dictates the works to him: The works spring from nowhere! The Shakespeare paradox is a false paradox. It is perfectly permitted to travel back in time and create a cause of a subsequent effect: It simply offends common sense. Much of quantum theory offends common sense and this is not a reason for forbidding it. In the Orch-OR system a limit is placed on the mass that can be in superposition for a time t. Macro paradoxes such as the Shakespeare paradox and Schrodinger's Cat are forbidden (or rendered vanishingly unlikely) without affecting the micro paradox of superposition—how can something be in two places at the same time . . .

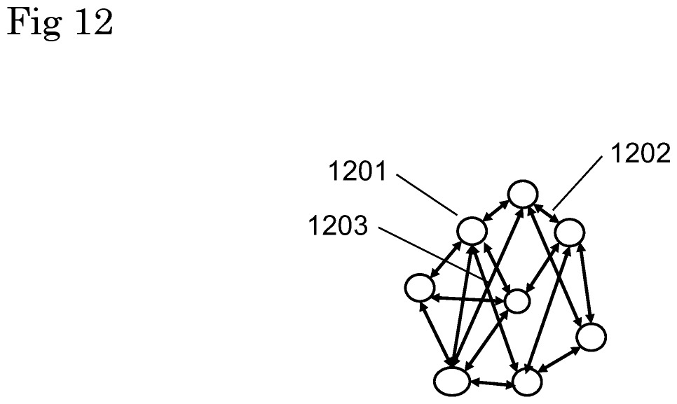

FIG. 12 Illustrates a neural network inspired construction of a QGC. In a neural network each computational element is linked to other elements according to a topology. There are commonly layers—including hidden layers and feed forward and backward paths. In such networks wiring defines the allowed paths along which signals may pass. In a preferred embodiment of a QGC one or more of these ‘layers’ is replaced by a maximally-connected network. Quantum signals which encounter this network may spread out and couple to any node via long 1203 or short 1202 paths. It can be modelled as a one to many (all) network, a portion of which is drawn in FIG. 12. As this network increases the number of ‘connections’ that would need to be drawn increases greater than exponentially so only a small number of elements are illustrated. The quantum information spreads over this network depending on many factors including the coupling sensitivity of the nodes, their separation and the excitation state of nodes in the network. A classical description of this can be found in reference Silva of which the following is a short excerpt.

Within a complex dynamic network, there are two topologies: a static structural topology that describes all the possible connections within the network and a dynamic functional topology that establishes how a signal propagates through the static topology. Functional topologies are subsets of the structural topology and vary depending on the functional connectivity, internal dynamics of individual vertices, and the specific stimulus to the network. In other words, cells that are physically connected need not necessarily signal each other. Having said this, though, in cellular neural circuits and networks, structure and function influence each other, and the states of cells and the connections between them may change with time as a function of plasticity mechanisms.

Because this is a dynamic emergent network there is no particular need to perform a specific function at each node. All that is needed is that there is some arbitrary function at each node that receives input photons and emits output photons according to some relationship between the input photons: coupling, frequency, phase, polarization, time arrival or similar quantum encoded state. In this quantum gravity implementation there is no matter of fact as to the state of the network, no fixed causal structure and any excited state of a node may be in superposition and entangled with the excitation state of another node. Learning and programming occur by making some change to the function of each node again modifying relationship between the input photons, coupling, frequency, phase, polarization, time arrival or similar quantum encoded state.

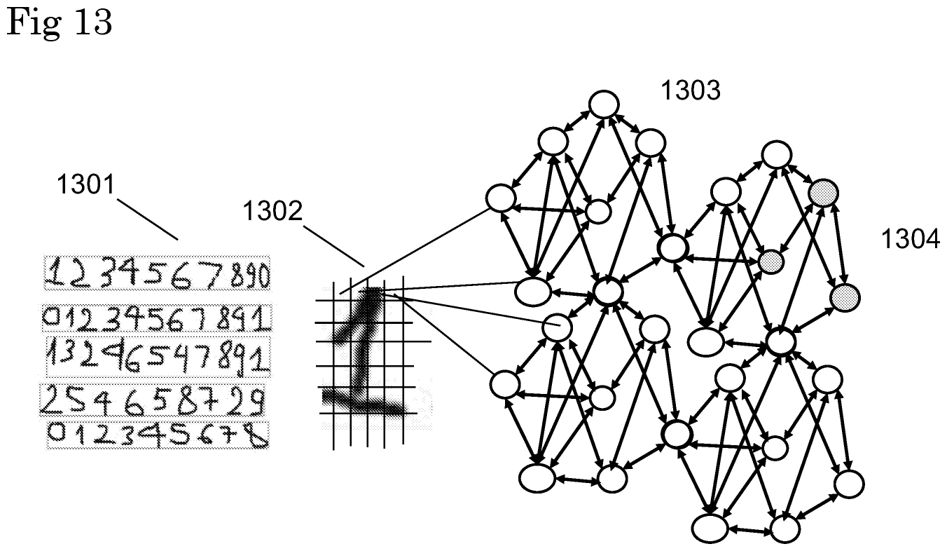

FIG. 13 illustrates the standard MNIST data set for testing Al 1301. Hand written characters are input to the QGC neural network by setting an input layers based on a pixel array 1302 to 1303. The QGC neural network will form a dynamic pattern based on the input letter 1304—trivially this might be a triangle between three elements but in general will be a complex stable dynamic pattern. This stable pattern can be recognized to provide the output of the system. A benefit of using a dynamic stable pattern is that long lived qubits are not needed. The system can be trained to collapse reaching the E_{g} threshold once a recognition event has occurred.

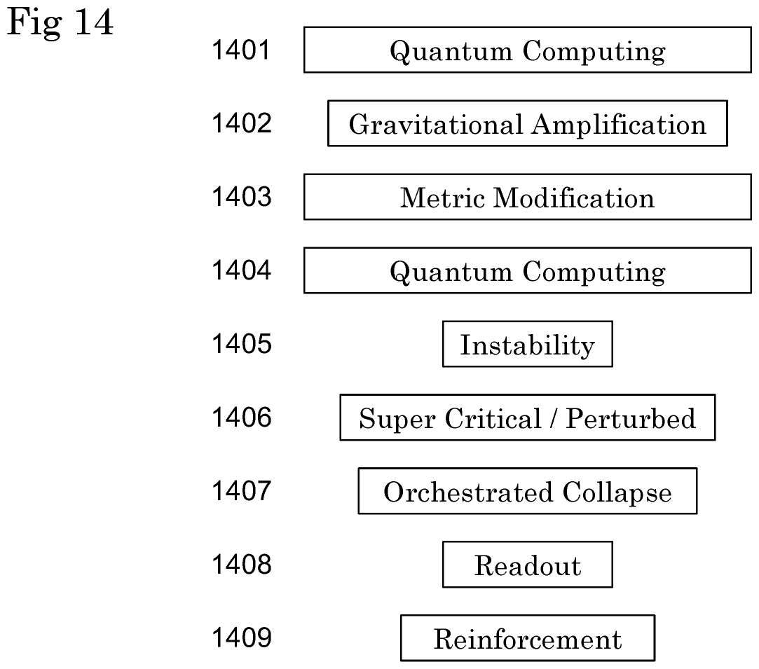

FIG. 14 Describes the process by which a quantum gravity computer generates an output. It should be noted that numbering, time or step sequence might not have significance as this is not a step computer and so these operations could occur simultaneously or in any order. Statistically an output emerges and conceptually those statistics match, to some extent, a procedural description. A procedural explanation will now be given taking note of this caveat A quantum computation is executed 1401. The qubit states will be modified by the operation of gates and these state changes will move a certain mass-energy resulting in distortion of the space-time metric. In an optimal QGC a mechanism is provided to amplify the gravitational effect of the qubit movement using proteins that flex and move appreciable mass dependent on their state 1402. This might be by opening a gate and allowing electrons to flow from one capacitor to another or by modifying a protein such as redopsin which will fold to a dramatically different topography based on the energy of a single electron in the molecule. Thus, the superposed qubit state may result in a superposed space-time metric 1403. Further quantum computation may occur where, due to the modified space-time metric the cause and effect relationship of inputs to gates may be in question 1404. Thus, the computation is in a state where there can be no matter of fact as to what state or program has been executed. Quantum computation results in qubits becoming entangled with each other and thus so-called Bell states or EPR states are established. Qubits have modified the metric of space-time in an entangled manner. This is an unstable state 1405, regions of the system if summed together in a particular way would exceed the E_{g} limit. However, there is no arbiter to decide how the sum should be made and so the system has an intrinsic instability. This state is rather like the super-critical state in crystallization or freezing. At some point either the system becomes so super critical that it must collapse to a state or a small perturbation of imperfection triggers collapse 1406. This collapse is complex—orchestrated we say 1407—as the nature of the collapse in one area affects the nature of the collapse in others in a non-local fashion. Once sufficient collapse has occurred to bring the system under its critical limit the system returns to computation and a readout can be made 1408. Based on the nature of the readout and normal neural network learning mechanisms the weights of the quantum computing structure are modified to reinforce 1409 good behavior.

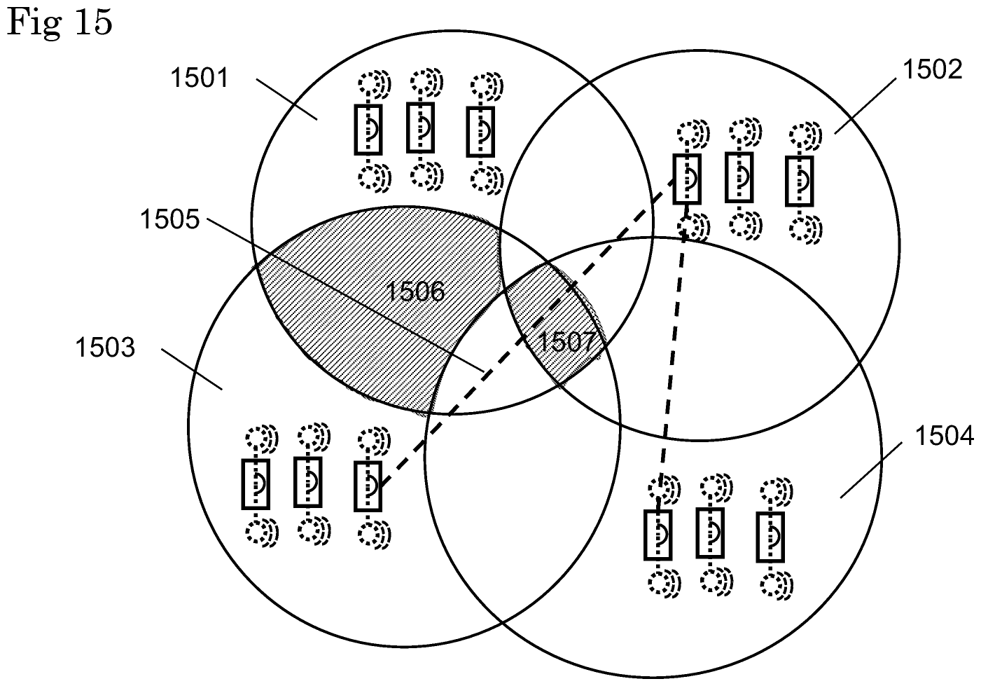

FIG. 15 illustrates the condition in which gates occupy regions of space 1501-4 and are entangled by relationships indicated by dashed lines 1505. The metric will be affected by the state of gates within a certain region and metric modifications occur at the speed of light such that certain regions such as 1500 may be affected by the metric distortions of gates in regions 1501 and 1503. And certain other regions 1507 may be affected by the gravitational distortions of gates in many regions 1501-4. One can immediately see that the distinctions of regions is an arbitrary conceptual overlay and has no true meaning other than to provide a way in which to model the system. A given point in space time Will be subject to elements within its past (uncertain and superposed) light cone. It is also worth noting that entanglement effects 1505 are independent of space-time light cones. Two qubits might be outside each other's light cones yet quantum entangled. The modulation of space-time by the quantum superposed states results in areas of space-time having incompatible metrics. Space-time at the large scale appears smooth and linear. It cannot maintain two contradictory curvatures. Thus, regions of space-time become unstable and superpose different states. These superpositions are very complex as they are affected by both the metric variation and by logical constraints imposed by the entanglement of different qubits. This forms a super-critical 1406 energy state FIG. 14 in which the system must collapse into a single state but it is unclear as to how the state should collapse—and impossible to model on a quantum computer. Because there are regions which are space-like separated that contain entangled qubits there can be no causal process by which to model the collapse and there can be no mater of fact about the state prior to collapse that would allow us to form an input to a Turing algorithm to model the process. However, the constraints of space-time mean the state ‘must’ collapse and so it does in step 1407. The state can be imagined to crystalize out and metric state of each region becomes sufficiently certain. This means that the location of masses is once again certain to the degree required to be sub-critical and looking at these masses allows us to ‘see’ the result of the ‘computation’. Of course, neither of these two words is correct. The locations of masses might be the position of a finger or the state of certain photons on the retina. Rather than considering that the state has been read out it is more correct to say the state has been imposed upon the world. There is no requirement in this system for full collapse. Only sufficient collapse is required to bring the system within sub-critical limits again. Thus, the system may display a variety of oscillatory modes as it transitions from super-critical to subcritical state and back to super-critical again.

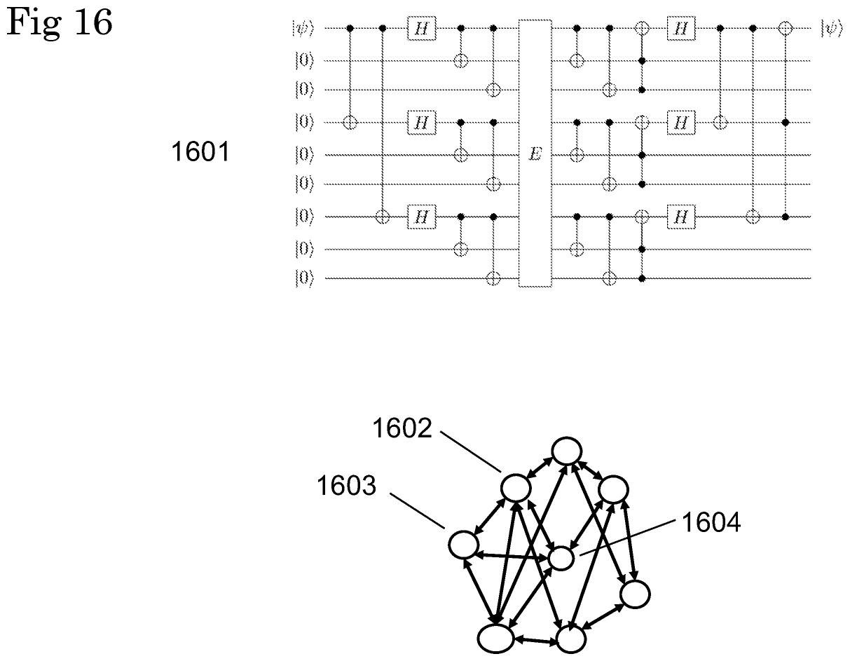

FIG. 16 Illustrates the standard Shor code 1601 for quantum error correction. A full explanation can be found at https://en.wikipedia.org/wiki/Quantum_error_correction. Implementing this in quantum logic allows for an error corrected store of quantum information that can be manipulated without errors increasing that swamp the result. In our system quantum error correction is an emergent property of the dynamic network. A stable pattern will emerge that cycles around the triangle 1602, 1603, 1604. The diagram is much simplified as one to two orders of magnitude more nodes are required for implementation but the conceptual idea is illustrated. The pattern would not stable if errors accumulated and it would dissipate. Stable patterns are the only ones that emerge because they are intrinsically error correcting.

FIG. 17 Illustrates a layout for the QGC implementation. A series of quantum gravity gates (QGG)—somewhat equivalent to neural network nodes—are deposited onto a substrate which is organized into a series of interlocking fingers or a snaking paths. The QGG elements are formed of graphene tuned to a particular wavelength and spaced along the finger so that they coherently transport energy along a finger. Portions of graphene compound move with respect to the substrate when excited. At the end of each finger a connecting element transports energy from one finger to the next and computation occurs in the other direction along an adjacent finger, Quantum resonant gravity gates (nodes) are laid out along the snaking paths 1701, 1702, 1703. The nodes are able to communicate most readily with each other along the main pathways but are entangled 1704 and gravitationally effective laterally 1705. The nodes of the quantum gravity computer are not wired as a conventional computer might be, rather the gates are simply placed at the correct interval and computation occurs because of quantum resonant coupling between gates. Such coupling is inspired by the mechanism in photosynthesis. The arrows show interconnection between nodes schematically but should show influence between every node—the strength of coupling diminishing degree at farther distance.

Photons are introduced to the end of the substrate 1 706 and take ‘all’ paths through the matrix of gates. The dynamics of the network processes information. (ref Functional Topology of the Complex Dynamic Geometric Networks, Silva for detailed explanation). Photons may be of the same frequency as is given out by oxygen respiration of mitochondria i.e. blue light.

The graphene gates can be addressed from the silicon chip below and differing charges put onto them to effect different processing. This can be to implement weights for memory and learning. Equally as the gates process information they affect the charge in the SiO2 section which can be read to determine the state of the graphene dot.

By looping the computational structure back on itself a calculation that proceeds along the interdigitated path can be near its origin topographically despite being topologically distant. The processing elements at the nodes are made from Graphene Quantum Dots but could be made from different molecules such as tryptophan, redopsin or even linear optical processing elements,

According to the Penrose OR hypothesis once sufficient metric uncertainty is generated space-time can no longer bifurcate into the many possibilities and a spontaneous self-measurement of the superposed gravitational states occurs. It is not possible to make a procedural calculation of this collapse and in our system the mass superposition is distributed across many entangled elements. The best way to visualize the collapse process is as a phase transition: The system crystalizes.

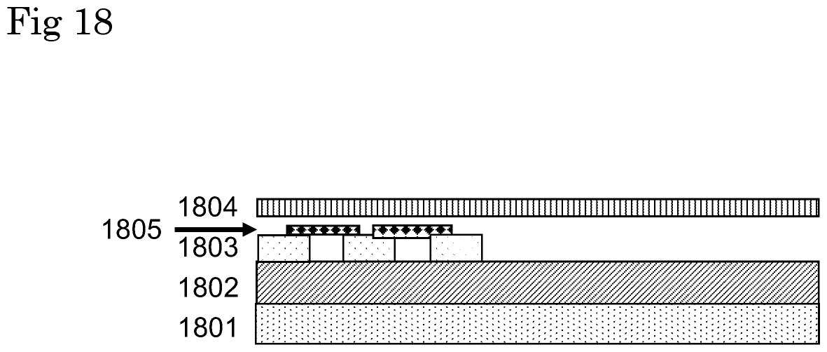

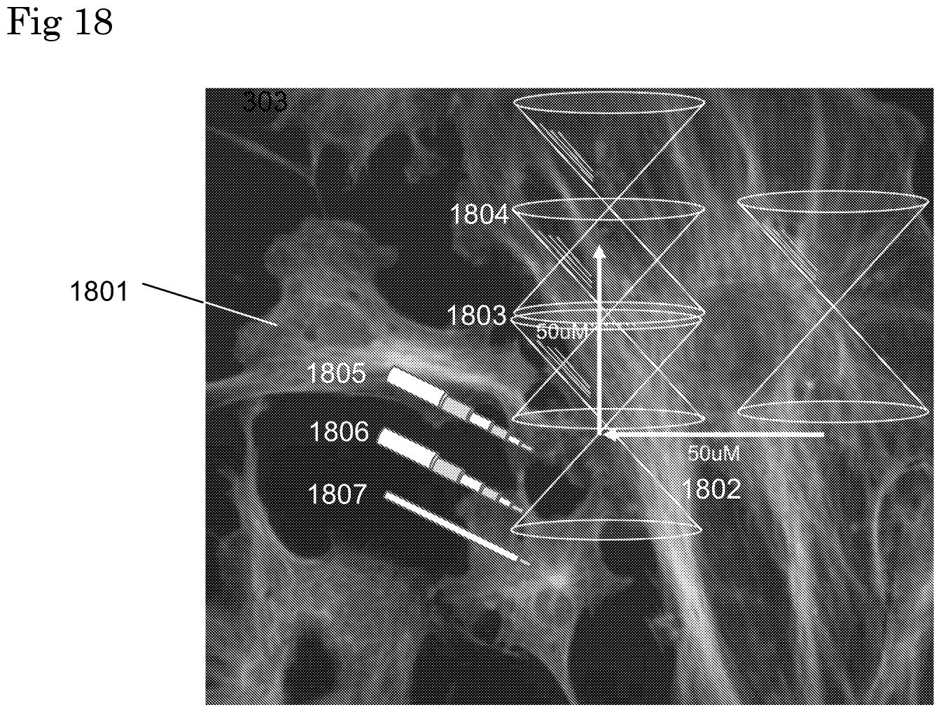

FIG. 18 illustrates a side view of the graphene on silicon system. A computer circuit 1802 is created on a substrate 1801, Graphene on silicon is deposited on silicon areas insulated by SiO2 areas. A top wave guide 1804 is placed on pillars over the graphene connection layer 1803. Standard chip fabrication technology can be used to construct the system.

FIG. 19 illustrates a quantum gravity computer built from neurons 1801. Neurons can be grown in the laboratory from stem cells or microtubules can be synthesized in the laboratory from tubulin. Tubulin will self-assemble into microtubules in an aqueous solution and tubulin will preferentially assemble if subjected to electromagnetic radiation at the appropriate frequencies. One benefit of building biological quantum gravity computers is theft matrixes are generally three dimensional. Three-dimensional chip technology is still a technology in its infancy. They can also be constructed at large scale due to fact they self-assemble or grow organically.

It can be seen from the diagram that light cones 1803, 1804 superposed on biological human neuron allow uncertainty at the edge of light cones within the same neuron. In this diagram we have superposed the scale of time on the y direction of space shown vertically. This can be done without difficulty since the speed of light c is a constant and we imagine processing occurs along the length of the microtubule fibers within the neurons in the vertical axis so that time wrt processing elapses along the y axis 1802. In order to use neurons as a computational element it is necessary to input and output signals from the bundle of neurons or microtubules. This can be done through electrical stimulation and recording or optical stimulation and either optical or electrical recording.

To facilitate this one or more fiber optic cables 1807 is inserted through the wall of the neuron into the microtubule and one or more triaxial probes 1805, 1806 are inserted through the wall of the neuron into the microtubule. Signals are inserted and measured and the neuron arrangement can be trained to process signals. Neurons self-train in that they do not require a reward mechanism over and above attention. Positive reinforcement for training is achieved through providing differential stimulus for a ‘good’ response or a ‘bad’ response. Neurons automatically work out how to learn based on unlabeled reinforcement information.

Note that in this QGC we have constrained the physical location of the dots in space and are allowing the time dimension to carry the bulk of the uncertainty. In a biological quantum computer, the substrate is flexible and typically formed of strands which float in an aqueous medium. This is the model that microtubules form in a neuron with MAP flexible proteins forming the quantum gravitational gates. These gflex proteins™ have three main functions: they are controlled optical switches, they move mass based on their state, they provide for coherent energy transfer between elements. Example gflex proteins include Tryptophan and Redopsin.

1. A device which operates upon physicalized information using both the principles of quantum mechanics and general relativity.

2. The device as claimed in claim 1, device that operates upon information without recourse to step-wise computation.

3. The device as claimed in claim 1, device that operates upon information that cannot be simulated by a step-by-step computer or algorithm and, is not subject to the limitations of the halting problem.

4. A device that operates upon information comprising:
a matrix of processing elements without definite position in space-time, capable of superposition, entanglement and communication with other elements through a multiplicity of quantum paths; and.
input means to quantum excite selected elements of said processing matrix; and output means capable of performing an action upon sufficient accumulation of space-time separation of the superposed processing elements.

5. The device as claimed in claim 4, further comprising a computer composed of functional elements which are capable of manipulating qubits and the displacing mass in operation so that the result of the action of the element on the qubit is sensitive to both quantum and gravitational factors.

6. The device as claimed in claim 4 further comprising a processing system that can implement a watch dog function which is not subject to modelling by combination of state with the function which is subject to the watchdog.

7. The device as claimed in claim 4, further comprising a combination of human neurons and computer chip technology so designed as to be able to solve non-computable problems.

8. A processing system comprising:
a matrix of quantum elements capable of interacting with one or more superposed entangled electromagnetic data signals in response to the presence of one or more, optionally superposed entangled control signal, arranges such that they modulate the space-time metric based on status of the matrix elements,
a means for varying one or more control signals and,
a means for output of information based on the status of the matrix.

9. The system as claimed in 8 where the other signal is a light

10. The system as claimed in 8 where the modulation the space-time metric is accumulated over a number of successive runs of processing.

11. The system as claimed in 8 where the processing matrix is laid out in a linear, interdigitated fashion.

12. The system as claimed in 8 where the processing matrix is laid out in a three-dimensional convoluted fashion.

13. The system as claimed in 8 comprising means by which the process can be approximately simulated on a classical or quantum computer.

14. (canceled)

15. The system as claimed in claim 8, comprising a computer like device where computation is sensitive to both the laws of quantum mechanics and general relativity.

6. The system as claimed in claim 8, comprising a means for teaching biological or synthetic neurons to learn through differential stimulus to a response.

17. (canceled)

18. The device as claimed in claim 4, wherein the output means is by way of a quantum measurement process.
